(19) United States
(12) Patent Application Publication
(10) Pub. No.: US 2026/0329261 A1
(43) Pub. Date: Oct. 22, 2026

(54) METHOD FOR COMPUTER-SUPPORTED PROVISION OF AN ADAPTATION SPECIFICATION FOR ELECTROTECHNICAL INSTALLATION TECHNOLOGY

(71) Applicant: Murrelektronik GmbH, Oppenweiler (DE)

(72) Inventors: Sebastian Pfestorf, Backnang (DE); Paul Zeller, Flein (DE)

(21) Appl. No.: 19/112,380

(22) PCT Filed: Sep. 29, 2023
(86) PCT No.: PCT/EP2023/077004

§ 371 Date: Mar. 17, 2025

(30) Foreign Application Priority Data
Sep. 30, 2022 (EP) 22199162.3
Sep. 30, 2022 (EP) 22199167.2
Sep. 30, 2022 (EP) 22199171.4
Sep. 30, 2022 (EP) 22199182.1

(51) Int. Cl. G05B 19/418

(52) U.S. Cl. CPC G05B 19/41845; G05B 19/4184

(57) ABSTRACT

The invention relates to a method (100) for the computer-aided provision of a modification specification for an electrotechnical installation technology, and preferably for an electrical sensor technology and/or actuator technology in a machine (10), in particular for an electrotechnical plant (10), preferably automation plant, comprising:
Determining (101) a measure specification which specifies a user-defined measure in which at least a part of the machine (10) is modified and/or supplemented and/or replaced for a maintenance of the machine (10), and which is provided for maintaining and/or supplementing and/or restoring a functionality of the machine (10),
Evaluating (102) a machine specification, wherein the machine specification specifies at least a structure of the machine (10), wherein the evaluation (102) uses the structure to automatically identify at least one modification to the machine (10) which is necessary to carry out the user-defined measure in order to maintain and/or restore the functionality of the machine (10),
Generating (103) the modification specification based on the performed evaluation (102), wherein the modification specification specifies the at least one identified modification,
Providing (104) the modification specification for the maintenance of the machine (10).

The present invention relates to a method for the computer-aided provision of a modification specification for an electrotechnical installation technology. Furthermore, the invention relates to a computer program and an apparatus for this purpose.

### STATE OF THE ART

It is well known that electrical plants regularly require maintenance after installation and commissioning, and that parts of the machine may need to be replaced in this context. Maintenance may be problematic if replacement parts are not available or the requirements for the machine change. In such cases, an enormous amount of effort is often required to identify alternative replacement parts and use them for this purpose.

It is also known from the state of the art that electrotechnical plants are not only designed with a central topology with a central control cabinet, but may alternatively or additionally also have a decentralized topology. This allows actuators and sensors to be at least partially connected decentrally via connection modules and connected to a central control device such as a PLC.

### DISCLOSURE OF THE INVENTION

It is a task of the present invention to at least partially eliminate the disadvantages described above. In particular, it is the task of the present invention to enable improved installation and maintenance of parts of an electrotechnical machine.

The object of the invention is a method having the features of claim 1, a computer program having the features of claim 14 and an apparatus having the features of claim 15. Further features and details of the invention are apparent from the respective subclaims, the description and the drawings. Features and details described in connection with the method according to the invention naturally also apply in connection with the computer program according to the invention and the apparatus according to the invention, and vice versa in each case, so that reference is or may always be made mutually to the individual aspects of the invention with regard to the disclosure.

The object of the invention is, in particular, a method for a computer-aided provision of a modification specification for an electrotechnical installation technology, and preferably for at least one machine component such as devices and/or an electrical sensor technology and/or actuator technology in a machine and/or for an electrotechnical plant, preferably automation plant.

A machine component may advantageously comprise at least one of the following within the scope of the invention:
at least one or more sensors,
at least one or more actuators,
at least one or more connection modules,
at least one or more adapters,
at least one or more distributors,
at least one or more switches,
at least one or more hubs,
at least one or more electrical fuses,
at least one or more power supply units,
at least one or more switches,
at least one or more safety devices,
at least one or more protection systems,
at least one or more lighting systems,
at least one or more signal converters,
at least one or more electrical transformers,
at least one or more cables,
at least one or more cameras
at least one or more image analysis tools,
at least one or more displays,
at least one or more operating components,
at least one or more generators,
at least one or more terminal boxes,
at least one or more connectors.

The “electrotechnical installation technology” refers in particular to (and includes in particular) measures for the installation and/or maintenance, in particular maintenance and/or expansion and/or networking and/or new creation and/or rescheduling, of such a machine, in particular electrical plant. In particular, it aims to ensure safe and efficient power and/or signal distribution in the machine, preferably electrical plant, and the specified functionality of the machine.

The machine may be designed as a (real) electrotechnical plant, which may thus have spatially distributed and decentralized various components and one or more control units. The control units may, for example, comprise at least one PLC (programmable logic controller) and/or at least one industrial computer. The control unit or at least one of the control units may also be designated or designed as a central control device. In the context of the invention, the components may also be referred to as machine components and comprise, for example, electrical components such as actuators and sensors. The sensors may be designed to record states or measured values of the machine (or plant), such as temperature, pressure or speed. The actuators may be designed to generate a mechanical effect. For this purpose, the actuators may include motors, pumps and/or valves, for example. Furthermore, the actuators may be controlled by the at least one control unit and the sensors may be evaluated by the at least one control unit. To make this possible, the at least one control unit and the machine components may be connected to each other via distribution modules. A communication network such as a fieldbus or an industrial Ethernet or the like may also be provided to connect at least part of the at least one control unit and/or the distribution modules and/or possibly also the machine components. Furthermore, operating and monitoring systems may be provided which, for example, include interfaces such as touchscreens or display instruments that provide the operator with information and enable control inputs. In addition, monitoring components and protective devices may also be provided which, in the event of malfunctions or dangerous situations, safely shut down the machine (or plant) or put it into a safe state. This enables the machine and, in particular, an automation system to carry out processes automatically, efficiently, repeatably and with high precision.

The method according to the invention may comprise a first method step of determining a measure specification. The measure specification may specify a user-defined measure in which at least a part of the machine is modified and/or supplemented and/or replaced for a maintenance of a machine, and/or which is intended to maintain and/or supplement and/or restore a functionality of the machine. The measure specification may thus be, for example, a user input in which a desired measure of an operator is technically specified.

Furthermore, the method according to the invention may comprise, according to a further method step, an evaluation of a machine specification, wherein the machine specification specifies at least a structure of the machine. The evaluation may use the structure to automatically identify at least one modification to the machine that is necessary to carry out the user-defined measure, preferably in order to maintain and/or restore the functionality of the machine.

Furthermore, according to a further method step, the method according to the invention may comprise generating the modification specification based on the evaluation carried out, wherein the modification specification specifies the at least one identified modification.

Finally, according to a further method step, the method according to the invention may comprise providing the modification specification for maintenance of the machine.

The method steps may be carried out sequentially and/or repeatedly and may be initiated, for example, by a user entering the measure specification.

The method may have the advantage of simplifying and improving computer-aided maintenance of the machine. In other words, for an existing machine (with an existing topology), an automatic modification may be proposed which is necessary or useful for a maintenance measure. It may be possible for the modification specification to be provided in a computer-aided manner in that a data processing apparatus performs at least some or all of the aforementioned method steps. Thus, the method according to the invention may also be computer-implemented.

The term “computer-aided” is to be understood in particular as meaning that during an activity of an operator on the real machine, the activity is supported by at least one data processing apparatus such as a computer. For this purpose, the modification specification may, for example, be generated based on a digital processing by the at least one data processing apparatus and output for the operator. The output may, for example, be visual via a display means such as a display and/or acoustic via a loudspeaker. The modification specification may include text information that clearly specifies to the operator what type of modification and/or how the modification is to be made. Accordingly, the modification specification may include at least one of the following:
A type of modification, e.g. a replacement of a machine component and/or a modification of at least one connection and/or a modification and/or a replacement of at least one distribution module,
An activity on the machine intended for modification, e.g. a shutdown of a machine component and/or a cable assembly and/or an order for replacement parts,
A place of modification, e.g. a point and/or a segment of the machine,
A time and/or duration of a modification, e.g. to determine a maintenance period,
A specification of at least one component required for the modification, e.g. a replacement part and/or at least one distribution module.

Similarly, the measure specification may contain at least one of the following:
A type of measure, e.g. a replacement of a machine component and/or a modification of at least one connection and/or a maintenance work and/or a preservation and/or an addition and/or a restoration of a functionality of the machine,
An activity on the machine intended for the measure,
A location of the measure, e.g. a point and/or a segment of the machine,
A point in time and/or duration of the implementation of the measure,
A specification of at least one component required for the measure, preferably a machine component, e.g. a replacement part,
A specification of the part of the machine which is modified and/or supplemented and/or replaced,
A specification of the functionality of the machine which is to be maintained and/or supplemented and/or restored.

The measure specification may be obtained, for example, by means of a user input and/or from an output of a predictive maintenance system or the like. Receiving the measure specification from a predictive maintenance system makes it possible to carry out the measure in the form of maintenance work on the machine or plant based on automated forecasts.

The modification specification may specify the identified modification, wherein the modification comprises, for example, a modification of a programming for the control device and/or of input and output addresses and/or a modification of the replacement part. The modification of the replacement part may be present, for example, if a replacement part specified in accordance with the measure specification is not available. Accordingly, the modification specification may then specify an alternative replacement part. At least two situations may occur:
The replacement part specified according to the measure specification is a replacement part of the same type as the replacement part specified according to the modification specification, but has a different technical specification (e.g. requirements of the replacement part in terms of single-channel or double-channel configuration and/or requirements in terms of power requirements or the like). A further modification to the machine may then be determined, such as the installation and/or replacement of at least one distribution module that supports the corresponding requirement. For example, an existing distribution module of the machine that supports single-channel must be replaced with one that supports double-channel in order to use the adapted replacement part.
The replacement part specified according to the measure specification is a replacement part of a different type than the replacement part specified according to the modification specification. For example, the replacement part specified in accordance with the measure specification may be a photoelectric sensor that needs to be replaced. If the evaluation determines that this replacement part is not available, another type of replacement part may be considered. Therefore, the evaluation may also determine a modification that provides for a different type of replacement part, e.g. a mechanical and/or a reed switch and/or an ultrasonic proximity sensor as an alternative replacement part. This may result in further modifications being necessary in order to use the alternative replacement part. These may also be indicated by the modification specification.

Furthermore, a machine specification may be provided. The machine specification may specify a structure of the machine in digital form, e.g. by means of at least one circuit diagram and/or a mechanical connection diagram and/or an electrical connection diagram, each of which may be available in digital form in a data memory and/or may be part of the machine specification. In addition, identifiers such as equipment identifiers and/or article numbers and/or manufacturer numbers and/or serial numbers of the components used in the machine may also be available and/or evaluated based on the machine specification. The aforementioned information specifies the structure accordingly and may be used to automatically identify the at least one modification to the machine that is necessary to carry out the user-defined measure in order to maintain and/or restore the functionality of the machine. The automated evaluation may, for example, comprise at least one of the following measures:
Determining an identifier for a machine component specified by the measure specification,
Checking, in particular using the determined identifier, whether the specified machine component is available for the measure,
Evaluating at least one database with information on the availability of machine components for testing,
Determining an alternative machine component if the specified machine component is not available for the measure,
Testing the alternative machine component for the measure, e.g. by simulating the functionality of the machine when the alternative machine component is used and/or by comparing the technical specifications of the specified and the alternative machine component to determine a suitability and/or an evaluation of the alternative machine component,
Checking whether and which modification(s) to the machine lead(s) to an improvement in suitability and/or assessment, e.g. by simulating the functionality of various modifications to the machine, wherein the various modifications are tested, e.g. rule-based, according to a predefined rule-based algorithm,
Identifying the at least one modification to the machine, wherein a modification is identified that leads to the highest suitability and/or assessment.

Furthermore, within the scope of the invention, it is optionally possible for the evaluation of the machine specification to comprise the following step, which is carried out automatically by an analysis program:
Analyzing the machine with regard to its topology, which may be at least partially decentralized, with machine components and/or distribution modules of the machine and their connections and/or functions preferably being evaluated and/or simulated segment by segment and/or iteratively based on the machine specification,
   wherein preferably the machine specification specifies the topology with regard to an arrangement of the distribution modules which are provided for the decentralized connection of the machine components to a control device in order to electrically and/or signal-technically control and/or evaluate the machine components based on control commands which are transmitted via a fieldbus from the control device to the distribution modules, wherein preferably the modification specification specifies a change in the topology and/or at least one of the machine components and/or at least one of the distribution modules to enable the user-defined measure to be performed,
   wherein preferably the measure specification specifies a replacement of at least one of the machine components, in particular if the machine component to be replaced is in a defective state. The analysis program may, for example, include a rule-based algorithm to automatically evaluate various modifications. For this purpose, a simulation of the functionality of the machine may also be carried out by the analysis program, which checks the effect of the modifications on the functionality. In this way, a suitability and/or evaluation of the respective modification may be determined. Advantageously, this enables the analysis program to determine the modification that leads to the highest assessment and/or suitability as the identified modification.

It may further be possible that the machine specification comprises an installation specification comprising a digitized electrical circuit diagram and/or a digitized mechanical blueprint of the machine to specify the structure of the machine at least at the time of installation and/or at a later time of modification of the machine. Thereby, the machine specification may comprise a machine control information to specify the functionality of the machine at least at the time of installation and/or at the later time of modification. Further, the at least one identified modification may comprise a modification of the machine control information. The machine control information may comprise and/or specify at least one of: a program and/or commands and/or input and output parameters such as addresses and/or a specification of connections, in each case for controlling at least one machine component and/or at least one distribution module. More specifically, the machine control information may specify the specific data, instructions and/or parameters required to control a workflow or a process in a machine or plant. The machine control information may, for example, be used for a central control device such as a programmable logic controller (PLC) and comprise sequences of commands and logics that are encoded in a special (in particular PLC) program. The logics are, for example, control logics that are written in a language that the PLC may understand (e.g. LAD, STL, FBD). These logics define how the machine should react to certain inputs or states. The input and output parameters may define the use of interfaces to the machine components and/or distribution modules. This allows inputs such as input and output parameters and outputs such as instructions to motors or valves to be used, i.e. received and/or sent. It may be possible for the machine control information to define the connection (i.e. via which ports and/or via which communication network and/or via which addresses) via which the inputs are received and/or the outputs are sent. The machine control information is thus dependent on a specific structure of the machine, which may be changed by the identified modification. Thus, it may be provided that the identified modification comprises a modification of the machine control information in order to take this change into account while ensuring the functionality of the machine.

For example, it may be provided that the provision of the modification specification comprises at least the following step:
Outputting a customized machine control information, preferably in the form of a machine control file and/or a configuration file, preferably based on an IO Device Description and/or GSD Markup Language structure, and/or a sensor configuration,
   wherein preferably the at least one identified modification comprises a modification of device addresses and/or device identifiers and/or input and output addresses of the machine control information, preferably for controlling at least one machine component by a central control device, particularly preferably PLC. The machine control information, especially in the form of control or configuration files, may thus include detailed information and/or parameters in order to reliably control and configure machines and plants. Standardized formats such as the IO Device Description (IO-DD) and the GSD Markup Language (GSDML) are of particular importance here. The IO-DD standardizes the properties and capabilities of IO devices, such as sensors and actuators, and thus facilitates their integration into control systems. GSDML, an XML-based language, describes device properties for PROFINET systems, for example. It is often provided by device manufacturers and may then be used for the installation and maintenance of the machine. Furthermore, the machine control information may include at least one sensor configuration file. This may indicate specific settings of a sensor so that its correct function in the machine is guaranteed. The machine control information may thus considerably simplify and optimize the installation and commissioning of machine components in the machine.

Furthermore, it may be provided that the provision of the modification specification comprises at least the following step:
Guiding a user step-by-step to perform the user-defined measure taking into account the identified modifications, preferably by specifying connections and/or a sequence of connections and/or a connection specification for the connections of at least one machine component, in order to integrate a replacement part into the machine.

The step-by-step guidance may, for example, be output by an output device, e.g. visually by a display and/or acoustically by a loudspeaker and/or by means of augmented reality. The guidance may, for example, comprise several instructions, in particular at least one of the following:
Safety instructions (“Make sure the machine is switched off and actuators are disconnected from the power supply before starting maintenance” or “If possible, make a backup of all important data and configurations”),
Preparatory instructions (“Determine the current condition of the machine”), Localization instructions (“Locate the specific machine component that requires maintenance”),
Test instructions (“Check the connection arrangement”),
Installation instructions (“Disconnect any physical connections or connectors leading to the machine component”, “Follow the specific instructions displayed by the computer to perform the actual maintenance procedure”),
Final instructions (“After completing the maintenance work, ensure that all connections and ports of the machine component are correctly and safely restored.”).

In addition, the step-by-step guidance may also include controlling and/or evaluating at least one machine component. This may be used to provide an operator with instructions (e.g. to light up a light from connections when a cable is to be connected to them) or to check the correct implementation of the guidance (e.g. by means of a connection check).

Advantageously, in the context of the invention, it may be provided that the modification specification is provided by outputting an adapted digitized circuit diagram and/or blueprint, preferably based on an ECAD or MCAD structure, and/or a connection configuration for the machine. The modification of said specifications such as the circuit diagram and/or blueprint and/or the ECAD (Electronic Computer-Aided Design) or MCAD (Mechanical Computer-Aided Design) structure and/or the connection configuration may, for example, be computer-aided by at least one of the following steps:
Importing the specification, e.g. by importing a file,
Checking the imported file, in particular a plan and/or structure defined in it, for errors or missing elements,
Modifying and/or adding elements and/or components, preferably by means of a component library, e.g. an ECAD or MCAD library,
Using routing algorithms to automatically check and/or establish and/or change connections between components,
Using a simulation to ensure that the modifications are correct and functional, e.g. by checking circuit diagrams for electrical functional capacity (especially ECAD) and/or structural or kinematic analysis (especially MCAD),
Updating a documentation, preferably parts lists and/or a connection diagram for the machine.

The modification specification may be provided, for example, by outputting the adapted specification and/or updated documentation visually and/or digitally and/or acoustically and/or physically (e.g. as a paper printout).

Preferably, it may be provided in the context of the invention that the evaluation is carried out based on a rule-based algorithm and/or a simulation of the machine in order to analyze individual parts of the machine as a function of the user-defined measure with regard to the at least one identified modification. The simulation may be used in the evaluation, e.g. in the form of an ECAD or MCAD simulation tool and/or a simulation tool based thereon. Furthermore, the simulation may be used to analyze the electrical curve and/or the behavior of the components and/or a mechanical load and/or an electrical load (such as energy consumption and heat generation).

Optionally, it may be provided that an automatic check is carried out in which the maintenance and/or addition and/or restoration of functionality and preferably compliance with technical specifications is checked in the event that the user-defined measure is carried out on the machine, preferably based on a simulation of the user-defined measure and the at least one identified modification.

It is optionally possible that the evaluation also includes the following steps:
Selecting at least one replacement part from a replacement parts catalog, preferably in the form of an electronic database,
Determining a technical specification for this replacement part,
   wherein the at least one modification is identified based on the determined technical specification. In a database, the replacement parts may, for example, be specified by a manufacturer and/or serial number and/or article number and/or part number and may be read out. In addition, further information such as technical specification and/or compatibility with other components and/or an availability (such as an available quantity) and/or a cost information may also be provided. This enables reliable identification of a suitable replacement part.

According to another possibility, it may be provided that at least the following step is carried out to determine the machine specification:
Determining an actual structure of the machine, preferably by determining the electrical machine components actually installed on the machine and/or their topology.

With existing machines in particular, the actual structure and especially the actual topology may deviate from the originally planned structure and thus possibly from the machine specification. It may therefore be useful to automatically determine the current structure of the machine and, if necessary, to update the machine specification on this basis. The evaluation of the updated machine specification then makes it possible to reliably determine the need to adapt the measure to the actual structure. The determination may also include reading out and/or querying the electrical components actually installed on the machine and their topology. To determine the actual structure, identifiers of the machine components may, for example, be received and/or determined using the real machine. For example, a communication network may be used to receive signals from the components and/or the distribution modules, which provide an indication of the identity of the components or distribution modules and/or their interconnection and thus the topology. If components cannot be read directly via the communication network, e.g. in the case of actuators such as motors, information about the identity of the components and topology may be obtained via the distribution modules.

According to an advantageous further development of the invention, it may be provided that an automatic optimization of the evaluation, preferably of a simulation within the evaluation, is carried out based on user-defined criteria, wherein the user-defined criteria comprise at least one of the following:
a general condition for the user-defined measure,
at least one user-defined preference for an application purpose of the machine,
a specified maximum installation time for a replacement part and/or an additional part for the machine,
a technical effort and/or complexity according to which the evaluation is optimized,
a component availability, according to which the evaluation is optimized,
a manufacturer's specification for additional parts that are installed on the machine as part of the user-defined measure.

This provides a sufficient data basis for modification.

For example, it may be envisaged that the machine specification specifies a topology of a plurality of distribution modules of the machine, which are preferably divided into an active and passive type, wherein the active distribution modules, in contrast to the passive distribution modules, are connected to a central control device via a data connection to control machine components connected to the distribution modules based on the data connection, wherein the type of the distribution modules may be taken into account in the evaluation, such that the at least one identified modification comprises at least one of the following modifications:
a change in the addressing of the machine components via the data connection,
a selection of the type for a distribution module to be included in the machine,
a selection of a number of connections for a distribution module to be included in the machine,
a selection of cables and/or adapters and/or distributors for the machine,
a selection of the type for a distribution module to be included in the machine as a function of machine components to be connected to it, in particular electrical components, preferably as a function of at least one requirement of a sensor technology and/or actuator technology.

The requirement may include, for example, a requirement for a connection, such as the requirement that at least one of the following connections must be present on a component: IOLink, data, signal, analog, digital, M5, M8, M12, port, Class A, Class B, Di (Digital Input), Do (Digital Output), DIO (Digital Input/Output). The requirement may also specify a requirement for at least one electrical property, e.g. a current requirement. IOLink may be a connection for using standardized IO technology, which enables communication with sensors and actuators in particular. Data connections may be provided for exchanging information, in particular in digital or analog form. Accordingly, a signal connection may enable the input and/or output of an analog or digital signal. Furthermore, M8 (connector type M8) and M12 (connector type M12) may be designed as connector types, which are used in particular in industrial automation. Class A (in particular a port with lower power requirements) and Class B (in particular a port with higher power requirements) may represent different categories of IO-Link ports of the component. Di (Digital Input) may be an input signal that has only two states, while Do (Digital Output) may be an output signal that also has only two states. A DIO (Digital Input/Output) connection may be designed as both an input and an output.

A further advantage within the scope of the invention may be achieved if the machine is controlled and/or structured and/or adapted based on the modification specification provided.

Another object of the invention is an apparatus for data processing, comprising means for carrying out the steps of the method according to the invention. The apparatus according to the invention thus has the same advantages as those described in detail with reference to a method according to the invention.

Another object of the invention is a computer program, in particular a computer program product, comprising instructions which, when the computer program is executed by a computer, cause the computer to carry out the method according to the invention. Thus, the computer program according to the invention has the same advantages as those described in detail with reference to a method according to the invention.

The computer may be a data processing apparatus, for example the apparatus according to the invention, which executes the computer program. The computer may have at least one processor for executing the computer program. A non-volatile data memory may also be provided, in which the computer program is stored and from which the computer program may be read out by the processor for execution.

It is also conceivable that the computer comprises at least one integrated circuit such as a microprocessor or an application-specific integrated circuit (ASIC) or an application-specific standard product (ASSP) or a digital signal processor (DSP) or a field programmable gate array (FPGA) or the like. The computer may further comprise at least one interface for data exchange, e.g. an Ethernet interface or an interface for LAN (Local Area Network) or WLAN (Wireless Local Area Network) or System-on-a-Chip (SoC) or another radio interface such as Bluetooth or Near Field Communication (NFC). Furthermore, the computer may be designed as one or more control devices, i.e. also as a system of control devices. The computer may, for example, also be provided in a cloud and/or as a server in order to provide data processing for a local application via the interface. It is also possible for the computer to be designed as a mobile device, such as a smartphone.

Another object of the invention may be a computer-readable storage medium comprising the computer program according to the invention. The storage medium is designed, for example, as a data memory such as a hard disk and/or a non-volatile memory and/or a memory card. The storage medium may, for example, be integrated into the computer.

Furthermore, the method according to the invention may also be implemented as a computer-implemented method.

Further advantages, features and details of the invention are shown in the following description, in which embodiments of the invention are described in detail with reference to the drawings. The features mentioned in the claims and in the description may each be essential to the invention individually or in any combination. Shown are:

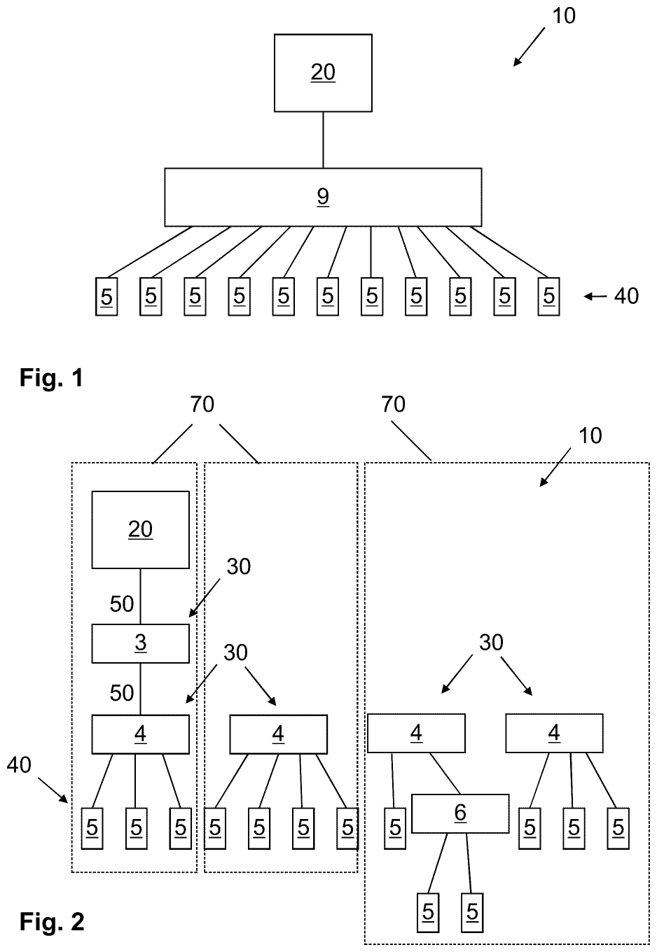

FIG. 1: A central connection in a machine by means of a control cabinet.

FIG. 2: A decentralized connection according to embodiments of the invention.

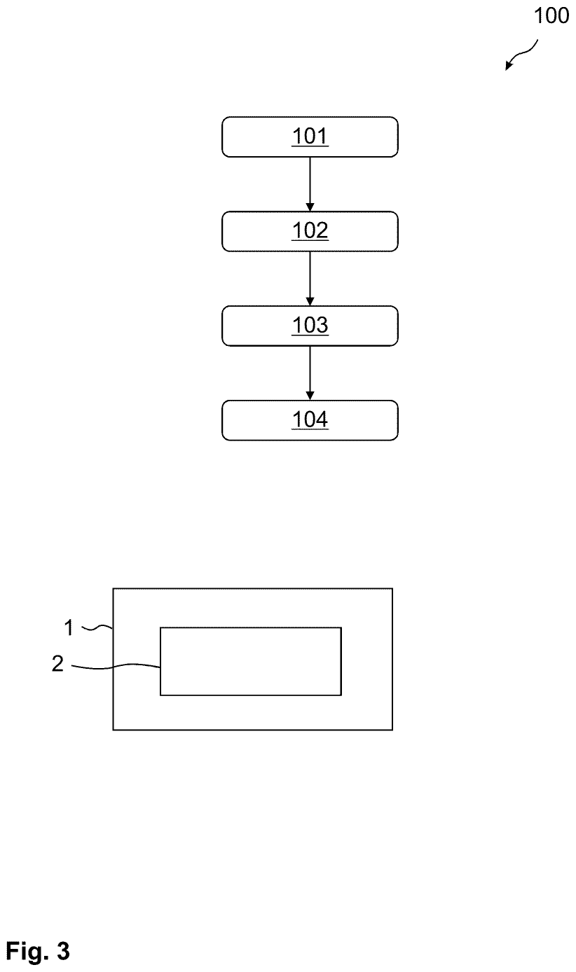

FIG. 3: A schematic representation for visualizing a method, a device and a computer program according to embodiments of the invention.

In the following figures, the identical reference symbols are used for the same technical features, even for different embodiments.

The planning and modification of a topology of electrical, decentralized automation technology is a time-consuming process when carried out by a human planner. In the same way, maintenance, e.g. servicing and supplementing the machine, often involves a great deal of effort. In the following, embodiments of the invention are described which substantially increase efficiency in planning and/or maintenance through automation based on machine specifications such as mCAD and/or eCAD data. This may lead to a higher assembly efficiency in the sense of an optimal arrangement of the components, as well as to a higher implementation efficiency, which is realized by providing a modification specification for a user, in particular a worker.

FIG. 1 schematically shows a centralized connection by means of a control cabinet 9 in order to contrast this with a decentralized connection by means of spatially decentralized electrical modules 3, 4 of a machine 10 in FIG. 2. The modules 3, 4 may comprise different types of a distribution module 30. In particular, the modules 3, 4 are divided into an active and a passive type of a distribution module 30. In this regard, the active distribution modules 30 may be connected to the central control device 20 via a data connection 50, in contrast to the passive distribution modules 30, in order to control machine components 40 connected to the distribution modules 30 based on the data connection 50. In other words, unlike active distribution modules 30, passive distribution modules 30 may provide the connection between control device 20 and devices 5 in a “hard wired” manner. This is particularly important to consider when evaluating 102 by the method 100. The machine components 40 may include devices 5 such as sensors and actuators.

Instead of connecting all devices 5 directly to the control cabinet 9, as shown in FIG. 1, several modules 4 may be used in the decentralized connection in FIG. 2 as at least a partial replacement for the control cabinet. Like the control cabinet 9, these enable the devices 5 to be coupled with the control device 20 such as a PLC. However, the modules 4 may be provided in a decentralized and distributed manner in the vicinity of the devices 5. The individual modules 4 thus only partially interconnect the devices 5, wherein the modules 4, optionally each via one and/or more hubs 6, may together carry out the entire interconnection.

To enable the modules 4 to be configured and/or controlled centrally, a master module 3 may be connected upstream of several of the individual modules 4. It is also possible for the interconnection to be further subdivided by means of at least one hub 6.

FIG. 3 illustrates, according to embodiments of the invention, a method 100 for the computer-aided provision of a modification specification for an electrotechnical installation technology, and preferably for an electrical sensor technology and/or actuator technology in a machine 10, in particular for an electrotechnical plant 10, preferably automation plant. In addition, FIG. 3 shows an apparatus 1 and a computer program 2 according to embodiments of the invention, which may be provided for carrying out the method 100.

The maintenance of electrical automation technology is a complex task. This applies to centralized control cabinet concepts as well as decentralized concepts in which control modules are attached directly to the plants. The corresponding processes are carried out by different people, such as plant planners, electrical planners, installers, system programmers, etc. Modifying the machine involves a great deal of effort and requires precise knowledge of the machine's functional relationships so that the existing functionality may be maintained. When replacing defective parts, replacement parts of the same type are therefore usually used.

One of the main challenges here is the modification and expansion of an existing machine, particularly for maintenance purposes. It is possible that faulty parts of the machine need to be replaced or the machine needs to be functionally supplemented or improved. To do this, new parts must be connected to the machine in such a way that the existing requirements are met and functionality is maintained.

In particular, if the structure of the machine has changed after the initial installation and/or if the availability of replacement parts is poor, it may also be necessary for further modifications to be made to the machine in addition to a maintenance measure in order to enable the maintenance measure to be carried out in such a way that existing or new requirements are met. The identification of such a modification may be automatically supported by the method 100 according to embodiments of the invention.

According to a first method step 101, a measure specification is first determined for this purpose. The measure specification may specify a user-defined measure in which at least a part of the machine 10 is modified and/or supplemented and/or replaced for maintenance of the machine 10. The measure may be provided for maintaining and/or supplementing and/or restoring a functionality of the machine 10.

According to a second method step 102, an evaluation of a machine specification may be provided. The machine specification may specify at least a structure of the machine 10. The evaluation 102 may use the structure to automatically identify at least one modification to the machine 10 that is necessary to perform the user-defined measure in order to maintain and/or restore the functionality of the machine 10.

According to a third method step 103, the modification specification may be generated based on the evaluation 102 performed, wherein the modification specification specifies the at least one identified modification. Then, according to a fourth method step 104, the modification specification may be provided for maintenance of the machine 10.

The modification specification may propose a modification measure that is carried out in addition to the maintenance measure (maintenance measure) in order to further optimize the maintenance of the machine and/or to ensure technical feasibility due to requirements that have arisen as a result of changed components and/or parts and/or replacement parts availability.

Automating the process for the maintenance of a machine 10 makes life much easier for the installer and ensures the optimum system design. By taking into account a machine specification, e.g. by reading in mCAD data and/or eCAD data and, if necessary, reading out the electrical components actually installed on the machine and their topology, the method 100 may independently recognize necessary modifications and, if necessary, support the step-by-step installation of a replacement part. This may include, for example, instructions on which electrical components should be connected to each other and in which order this connection should take place. It may also be possible to quickly and error-free create a machine control file for modification of the programming of a control device 20 and a parts list for the automation technology used, based on the machine specification and preferably an automatically generated topology. Performing simulations may also make it possible to maintain the functionality of the machine 10 even if the topology has to be changed or no replacement parts of the same type are available. Suggestions for changing the topology may be made automatically.

A concrete example is the replacement of a light barrier. Normally, the replacement part must correspond to the type originally planned. However, if this replacement part is not available, very expensive (unnecessary cost) or difficult to obtain, another part (a different photoelectric sensor or a different type of detector) may be used. It may even be possible to improve the functionality of the machine by using a different replacement part. However, such a replacement with a different type of replacement part requires a great deal of planning and a very good knowledge of the machine 10. The method 100 enables this process to be automated. For example, a different light barrier or even a different type of sensor may be suggested to replace the light barrier to be replaced and thus a modification for maintenance may be specified.

For example, mechanical and/or electrical properties of the replacement part may be specified as a modification specification. For example, a digitally recorded topology may be used to evaluate whether and how the topology needs to be modified so that the functionality of the machine 10 is retained after replacement. For this purpose, the evaluation takes into account, for example, requirements of the replacement part with regard to a single-channel or double-channel configuration. Different distributors (i.e. distribution modules) that may support single or double channels may be selected or replaced as a modification. Depending on the configuration, the use of a T-piece may also allow the connection of two sensor technologies to one port as a modification. Depending on the type of output of the replacement part (analog or digital), A/D converters could be included in the topology as a further modification. The pin assignment could also be adapted if necessary. Adapters could be used to solve compatibility issues or extend functionality. Furthermore, ports could be programmed as both input and output to increase flexibility. This may also be part of a modification. A safety port could also be added as a further modification to ensure the safety of the plant. In addition, the power consumption of the electrical plant may need to be adapted. For example, a different power supply could be used or an additional power supply installed to cover higher energy requirements or increase the reliability of the power supply.

The computer program 2 shown in FIG. 3 may further comprise an analysis program which enables the evaluation 102 of the machine specification to be carried out automatically. In this regard, the machine 10 may be analyzed with respect to its topology. The topology may at least partially have the decentralized topology illustrated in FIG. 2. For this purpose, the machine components 40 and/or the distribution modules 30 of the machine 10 and their connections and/or functions may preferably be evaluated and/or simulated segment by segment and/or iteratively using the machine specification. In FIG. 2, exemplary segments 70 are shown with a dashed rectangle. The segments 70 may comprise functionally and/or spatially related parts of the machine 10.

The distribution modules 30 may enable the machine components 40 to be electrically and/or signal-controlled and/or evaluated based on control commands that are transmitted from the control device 20 to the distribution modules 30 via a fieldbus 50. However, this requires knowledge of the topology of the distribution modules 30, as illustrated, for example, in FIG. 2. Therefore, the machine specification may specify the topology with regard to the arrangement of the distribution modules 30. For this purpose, the machine specification also comprises an installation specification comprising a digitized electrical circuit diagram and/or a digitized mechanical blueprint of the machine 10 to specify the structure of the machine 10 at least at the time of installation and/or at a later time of modification of the machine 10.

Further, the machine specification may comprise machine control information to specify the functionality of the machine 10 at least at the time of installation and/or at the later time of modification.

Furthermore, the modification specification may specify at least one modification such as a change in topology and/or a change in at least one of the machine components 40 and/or at least one of the distribution modules 30 to enable the user-defined measure to be performed. The measure may, for example, consist of replacing a defective machine component 4 or adding a function to the machine 10. Often, such measures cannot be carried out without further modifications to the machine 10. The necessary and, in particular, optimal modifications may be indicated by the modification specification.

In order to carry out the measure together with the modification of the machine 10 provided for this purpose, the modification specification may be provided. In particular, this is to be understood as informing a user which modification is to be performed. This may include guiding the user step-by-step to perform the user-defined measure, taking into account the identified modifications. For this purpose, for example, connections and/or a sequence of the connections, a series connection of the devices and/or an indication of the connections for the connections of at least one machine component 40 may be indicated in order to perform the modification. It is further conceivable that a location of the modification is specified, for example by specifying the segment 70 of the machine 10 in which the modification is to be carried out (see FIG. 2). The sequence and/or the series connection may be necessary in order to meet technical requirements such as space and power requirements. The modification according to the modification specification may be necessary, for example, in order to take these requirements into account automatically.

The foregoing explanation of the embodiments describes the present invention solely by way of examples. Of course, individual features of the embodiments may be freely combined with one another, provided that this is technically expedient, without departing from the scope of the present invention.

### LIST OF REFERENCE SYMBOLS

1 Apparatus
2 Computer program
3 Master module
4 Module
5 Device
6 Hub
9 Control cabinet
10 Machine
20 Control device, PLC
30 Distribution module
40 Machine component, motor, sensor
50 Fieldbus, data connection
70 Segments
100 Method
101 First method step
102 Second method step, evaluation
103 Third method step
104 Fourth method step

1. A method for a computer-aided provision of a modification specification for an electrotechnical installation technology, in a machine comprising:
Determining a measure specification which specifies a user-defined measure in which at least a part of the machine is modified and/or supplemented and/or replaced for a maintenance of the machine, and which is provided for maintaining and/or supplementing and/or restoring a functionality of the machine,
Evaluating a machine specification, wherein the machine specification specifies at least a structure of the machine, wherein the evaluation uses the structure to automatically identify at least one modification to the machine which is necessary to carry out the user-defined measure in order to maintain and/or restore the functionality of the machine,
Generating the modification specification based on the performed evaluation, wherein the modification specification specifies the at least one identified modification,
Providing the modification specification for the maintenance of the machine.

2. The method according to claim 1, characterized in that
the evaluation of the machine specification comprises the following step, which is performed automatically by an analysis program:
Analyzing the machine with regard to its topology, which may be at least partially decentralized,
wherein the machine specification specifies the topology with regard to an arrangement of distribution modules which are provided for decentralized connection of machine components to a control device in order to electrically and/or signal-technically control and/or evaluate machine components based on control commands which are transmitted via a fieldbus from the control device to the distribution modules.

3. The method according to claim 1,
characterized in that
the machine specification comprises an installation specification comprising a digitized electrical circuit diagram and/or a digitized mechanical blueprint of the machine to specify the structure of the machine at least at the time of installation and/or at a later time of modification of the machine.

4. The method according to claim 1,
characterized in that
the provision of the modification specification comprises at least the following step:
Outputting a customized machine control information.

5. The method according to claim 1,
characterized in that
the provision of the modification specification comprises at least the following step:
Guiding a user step-by-step to perform the user-defined measure taking into account the identified modifications, in order to integrate a replacement part into the machine.

6. The method according to claim 1,
characterized in that
the modification specification is provided by outputting an adapted digitized circuit diagram and/or construction plan.

7. The method according to claim 1,
characterized in that
the evaluation is carried out based on a rule-based algorithm and/or a simulation of the machine in order to analyze individual parts of the machine as a function of the user-defined measure with regard to the at least one identified modification.

8. The method according to claim 1,
characterized in that
an automatic check is carried out, in which the maintenance and/or supplementation and/or restoration of the functionality in the event of the user-defined measure being carried out on the machine is checked.

9. The method according to claim 1,
characterized in that
the evaluation further comprises the following steps:
Selecting at least one replacement part from a replacement parts catalog,
Determining a technical specification for this replacement part,
wherein the at least one modification is identified based on the determined technical specification.

10. The method according to claim 1,
characterized in that
at least the following step is carried out to determine the machine specification:
Determining an actual structure of the machine.

11. The method according to claim 1,
characterized in that
an automatic optimization of the evaluation is carried out based on user-defined criteria, the user-defined criteria comprising at least one of the following:
a general condition for the user-defined measure,
at least one user-defined preference for an application purpose of the machine,
a specified maximum installation time for a replacement part and/or an additional part for the machine,
a technical effort and/or a complexity according to which the evaluation is optimized,
a component availability, according to which the evaluation is optimized,
a manufacturer's specification for additional parts that are installed on the machine as part of the user-defined measure.

12. The method according to claim 1,
characterized in that
the machine specification specifies a topology of a plurality of distribution modules of the machine, having active distribution modules, in contrast to passive distribution modules, the active distribution modules being connected to a central control device via a data connection in order to control machine components connected to the distribution modules based on the data connection, the type of the distribution modules being taken into account in the evaluation, so that the at least one identified modification comprises at least one of the following modifications:
a change in the addressing of the machine components via the data connection,
a selection of the type for a distribution module to be included in the machine,
a selection of a number of connections for a distribution module to be included in the machine,
a selection of cables and/or adapters and/or distributors for the machine,
a selection of the type for a distribution module to be included in the machine as a function of machine components to be connected thereto.

13. The method according to claim 1,
characterized in that
the machine is controlled and/or structured and/or adapted based on the modification specification provided.

14. A non-transitory computer medium storing instructions which, when executed by a computer, cause the computer to:
Determine a measure specification which specifies a user-defined measure in which at least a part of the machine is modified and/or supplemented and/or replaced for a maintenance of a machine, and which is provided for maintaining and/or supplementing and/or restoring a functionality of the machine;
Evaluate a machine specification, wherein the machine specification specifies at least a structure of the machine, wherein the evaluation uses the structure to automatically identify at least one modification to the machine which is necessary to carry out the user-defined measure in order to maintain and/or restore the functionality of the machine:
Generate the modification specification based on the performed evaluation, wherein the modification specification specifies the at least one identified modification; and
Provide the modification specification for the maintenance of the machine.

15. An apparatus for data processing comprising:
one or more processors; and
a computer readable medium commutatively coupled to the one or more processors, and comprising computing instructions, the computing instructions, when executed by one or mor processors, cause the one or more processors to:
Determine a measure specification which specifies a user-defined measure in which at least a part of the machine is modified and/or supplemented and/or replaced for a maintenance of a machine, and which is provided for maintaining and/or supplementing and/or restoring a functionality of the machine;
Evaluate a machine specification, wherein the machine specification specifies at least a structure of the machine, wherein the evaluation uses the structure to automatically identify at least one modification to the machine which is necessary to carry out the user-defined measure in order to maintain and/or restore the functionality of the machine;
Generate the modification specification based on the performed evaluation, wherein the modification specification specifies the at least one identified modification; and
Provide the modification specification for the maintenance of the machine.

16. The method of claim 2 further comprising at least one of:
(a) wherein machine components and/or distribution modules of the machine and their connections and/or functions are evaluated and/or simulated segment by segment and/or iteratively based on the machine specification;
(b) wherein the modification specification specifies a change in the topology and/or at least one of the machine components and/or at least one of the distribution modules in order to enable the user-defined measure to be carried out; and/or
(c) wherein the measure specification specifies a replacement of at least one of the machine components when the machine component to be replaced is in a defective state.

17. The method of claim 3, wherein the machine specification comprises machine control information to specify the functionality of the machine at least at the time of installation and/or at the later time of modification, wherein the at least one identified modification comprises an adaptation of the machine control information.

18. The method of claim 4 further comprising at least one of:
(a) Wherein the machine control information is output in form of a machine control file and/or a configuration file, based on an IO Device Description and/or GSD Markup Language structure, and/or a sensor configuration;
(b) wherein the at least one identified modification comprises a modification of device addresses and/or device identifiers and/or input and output addresses of the machine control information, for controlling at least one machine component by a central control device.

19. The method of claim 8 further comprising at least one of:
(a) the automatic check further comprises a compliance with technical specifications; and/or
(b) the automatic check is based on a simulation of the user-defined measure and the at least one identified modification.

20. The method of claim 10 further comprising at least one of:
(a) wherein the determining comprises determining the electrical machine components actually installed on the machine and/or their topology; and/or
(b) wherein identifiers of the machine components are received and/or determined based on the real machine.
